(19) United States
(12) Patent Application Publication
(10) Pub. No.: US 2018/0164106 A1
(43) Pub. Date: Jun. 14, 2018

(54) SYSTEMS AND METHODS FOR IDENTIFICATION OF LOCATION FOR RENDEZVOUS OF VEHICLE WITH PERSON FOR PICKUP

(71) Applicant: Lenovo (Singapore) Pte. Ltd., New Tech Park (SG)

(72) Inventors: Nathan J. Peterson, Oxford, NC (US); Russell Speight VanBlon, Raleigh, NC (US); Arnold S. Weksler, Raleigh, NC (US); John Carl Mese, Cary, NC (US)

(21) Appl. No.: 15/377,308

(22) Filed: Dec. 13, 2016

(51) Int. Cl. G01C 21/34; G05D 1/00; G05D 1/02

(52) U.S. Cl. CPC G01C 21/3438; G05D 1/0276; G05D 1/0011

(57) ABSTRACT

In one aspect, an apparatus includes a processor and storage accessible to the processor. The storage bears instructions executable by the processor to receive data pertaining to a location of a device, receive data pertaining to a location of a vehicle different from the device, identify at least one criterion for pickup of a person by the vehicle, identify a rendezvous location for pickup of the person, and control the vehicle to travel to the rendezvous location.

### BACKGROUND

As recognized herein, self-driving vehicles (sometimes called autonomous vehicles) can provide benefits to their users. For instance, self-driving vehicles can allow users to concentrate on other tasks while traveling since the self-driving vehicle is controlling vehicle travel. However, as also recognized herein, self-driving vehicles still lack the ability for convenient drop off and pickup of users. There are currently no adequate solutions to the foregoing computer-related problem.

### SUMMARY

Accordingly, in one aspect a vehicle includes an engine, a drive train and chassis, a battery, a processor, and storage accessible to the processor. The storage bears instructions executable by the processor to receive data from a device different from the vehicle, identify a location at which to rendezvous with a person based on the data, and control the vehicle to rendezvous with the person at the location.

In another aspect, a method includes receiving data pertaining to a location of a device, receiving data pertaining to a location of a vehicle different from the device, identifying at least one criterion for pickup of a person by the vehicle, and identifying a rendezvous location for pickup of the person.

In still another aspect, a first device includes a processor and storage accessible to the processor. The storage bears instructions executable by the processor to receive first data from a second device different from the first device, receive second data from a vehicle different from the first and second devices, identify a location at which the vehicle is to rendezvous with a person based on the first and second data, and command the vehicle to rendezvous with the person at the location.

In yet another aspect, an apparatus includes a first processor, a network adapter, and storage. The storage bears instructions executable by a second processor of a device for presenting a user interface (UI) on a display accessible to device and receiving, via the UI, input for a user to be picked up by a self-driving vehicle. The input indicates at least one criterion for pickup. The instructions are also executable by the second processor for issuing a command to the self-driving vehicle to rendezvous with the user based on the criterion. The first processor transfers the instructions to the device over a network via the network adapter.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of an example network of devices in accordance with present principles;

FIG. 3 is a block diagram of an example vehicle in accordance with present principles;

FIG. 4 is a block diagram of an example shopping center to illustrate present principles;

FIG. 5 is a flow chart of an example algorithm in accordance with present principles; and

FIGS. 6-9 are example user interfaces (UIs) in accordance with present principles.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

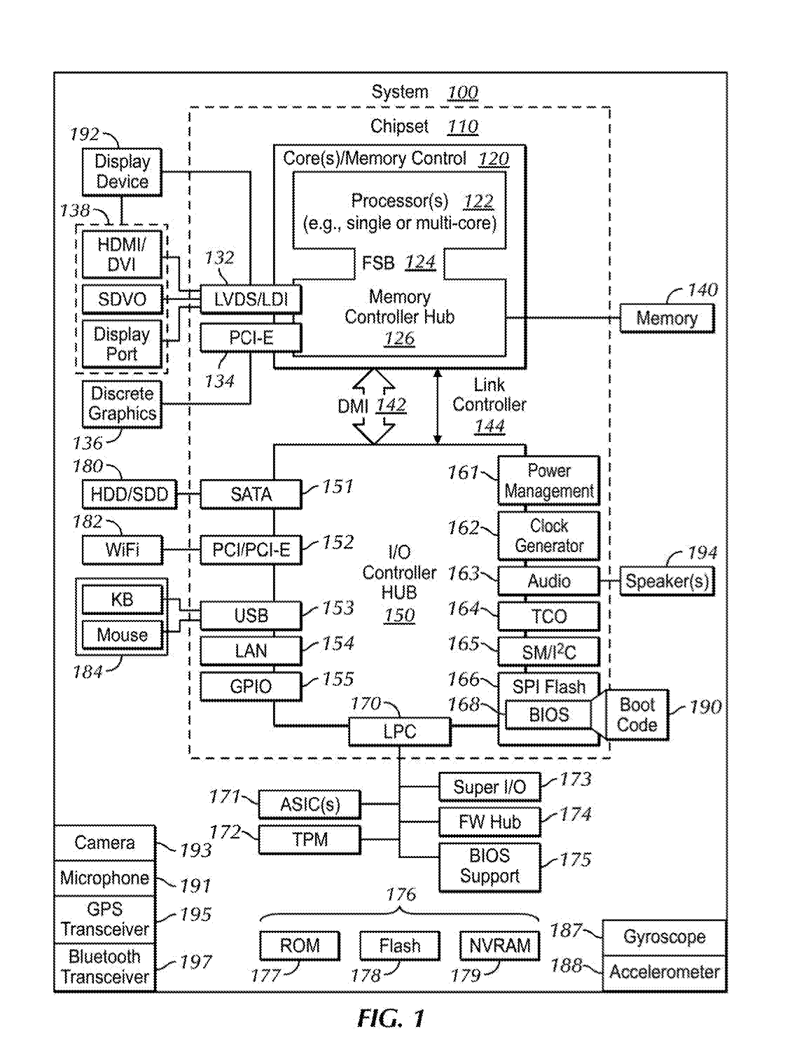

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Still further, the system may include a gyroscope 187 that senses and/or measures the orientation of the system 100 and provides input related thereto to the processor 122, and an accelerometer 188 that senses acceleration and/or movement of the system 100 and provides input related thereto to the processor 122. The system may also include an audio receiver/microphone 191 that provides input from the microphone to the processor 122 based on audio that is detected, such as via a user providing audible input to the microphone, as well as a camera 193 that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video.

Still further, the system 100 may include a GPS transceiver 195 that is configured to receive geographic position information from at least one satellite and provide the information to the processor 122. However, it is to be understood that another suitable position receiver other than a GPS receiver may be used in accordance with present principles to determine the location of the system 100. The system 100 may also include a Bluetooth transceiver 197 for Bluetooth communication, though other wireless transceiver types may be used such as a near field communication (NFC) transceiver for NFC communication or a Wi-Fi transceiver for Wi-Fi communication.

It is to be understood that an example client device or other machine/computer may include fewer or more features than shown on the system 100 of FIG. 1. In any case, it is to be understood at least based on the foregoing that the system 100 is configured to undertake present principles.

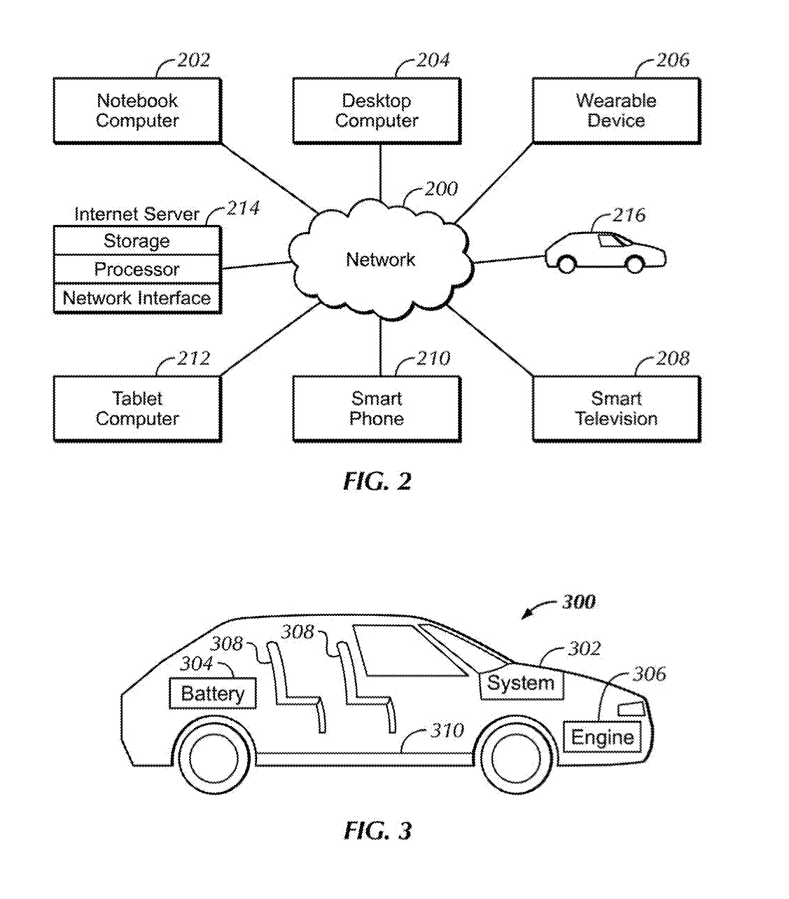

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a self-driving vehicle 216, and a server 214 such as an Internet server that may provide cloud storage accessible to the devices 202-212, 216. It is to be understood that the devices 202-216 are configured to communicate with each other over the network 200 to undertake present principles.

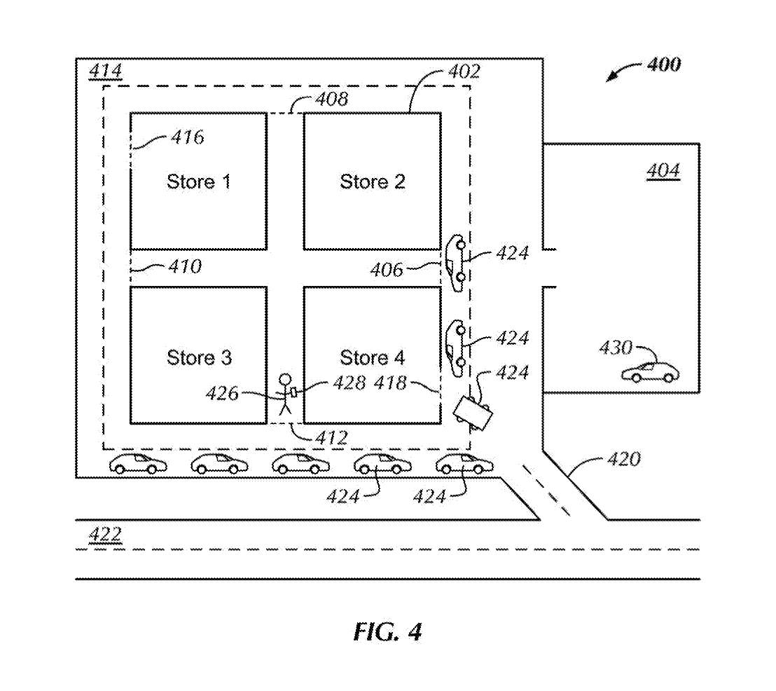

FIG. 3 shows an example self-driving vehicle 300 that may be similar to the vehicle 216 referenced above. The vehicle 300 may include a system 302 that may be similar to the system 100 described above and include components such as those set forth above in reference to the system 100. The system 302 may also communicate with and control a battery and/or battery pack 304 that provides power to other parts of the vehicle 300.

Additionally, the system 302 may communicate with and control an internal combustion engine 306 that can provide power to propel the vehicle 300 separately from or in conjunction with power from the battery 304 to propel the vehicle 300. The engine 306 may be a fossil fuels-powered engine, such as a gasoline-powered engine or a diesel-powered engine. The vehicle 300 may also include plural seats or chairs 308 in which a driver and passengers in the vehicle 300 may sit, as well as a drive train and chassis 310.

It is to be understood that the vehicle 300 may include still other components not shown for clarity, such as brakes for slowing and stopping the vehicle, as well as a regenerative braking mechanism for harvesting kinetic energy during braking of the vehicle to charge battery cells within the battery 304 through a battery charger that may also be included on the vehicle 300. Still other ways of charging the vehicle's battery may be used, such as charging the battery using energy taken from the engine 306 (e.g., using an alternator).

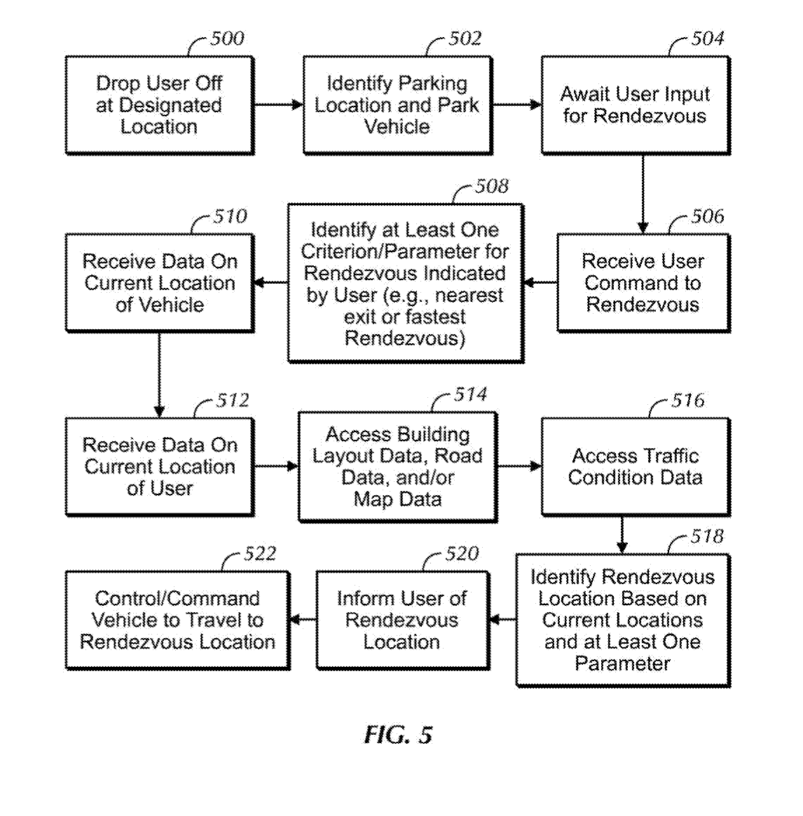

Referring to FIG. 4, an example block diagram 400 of a shopping center 402 and adjacent parking garage 404 is shown. The shopping center 402 has exits 406, 408, 410, and 412 to a shopping center driveway and/or street 414. Some of the stores of the shopping center 402 may even have their own exits 416 and 418. The shopping center street 414 has an outlet 420 onto a public street 422.

As may be appreciated from FIG. 4, there are multiple vehicles 424 waiting in traffic to exit the shopping center's premises onto the street 422. As may also be appreciated from FIG. 4, a user 426 is controlling his or her smartphone 428 to summon the user's self-driving vehicle 430 in the parking garage 404 to rendezvous with the user to pick up the user 426 at one of the exits. However, note that the self-driving vehicle 430 would encounter traffic when trying to reach exit 412, which is the nearest exit to where the user 426 is located, regardless of if the vehicle 430 traveled clockwise or counter-clockwise on the street 414 around the shopping center 402 to reach exit 412.

The user 426 may thus be made aware of the traffic conditions via the display of his or her smartphone 428, where traffic condition data for display may have been received from a third party source that crowd-sources user and device information for the people in the vehicles 424 to determine that they are moving at a slower rate of speed than expected on the street 414 and hence are encountering traffic. The severity of the traffic may even be ascertained based on the rate of speed. Cameras maintained by the shopping center 402 and accessible to the smartphone 428, vehicle 430, and other devices may also be used to identify traffic by using successive images from those cameras to determine that vehicles are present on the street 414 and are moving at a slower rate of speed than expected. Vehicle sensors disposed under the street 414 may also be used for such determinations.

Once the user 426 is made aware of traffic conditions, the user may choose where to be picked up by the vehicle 430. By providing input to the smartphone 428 which can then be transmitted to the vehicle 430 (either directly from the smartphone 428 or via a server, for instance), the user 426 may thus command the vehicle 430 to meet the user at a particular rendezvous point. For instance, the user may choose to still be picked up at exit 412 since that is the nearest exit to the current location of the user, such as may be the case if the user 426 has purchased a large amount of merchandise that he or she does not wish to walk to a farther exit with in order to rendezvous with the vehicle 430. In such an example, the user 426 may specifically indicate exit 412. Additionally or alternatively, the user may indicate that they wish to be picked up at a nearest exit, and then the smartphone 428 or other device operating in conjunction therewith (e.g., an Internet server and/or the vehicle 430) may determine the nearest exit, inform the user 426 of the nearest exit, and provide directions for the user to walk to that exit.

The user may also choose to be picked up at another exit of the shopping center 402 at which rendezvous with the user 426 can occur faster than rendezvous with the user 426 at the exit 412 owing to the traffic. Exit 406 may be selected, for instance. In such an example, the user 426 may specifically indicate exit 406. Additionally or alternatively, the user may indicate that they wish to be picked up as fast as possible, and then the smartphone 428 or other device operating in conjunction therewith may determine the exit at which rendezvous with the user 426 can occur the fastest, inform the user 426 of that exit, and provide directions for the user to walk to that exit.

Still further, the user 426 may elect to be picked up based on other criteria or parameters that the user inputs to the device 428. For instance, the user 426 may decide that since they have purchased a large amount of merchandise at the shopping center 402 and are also pushing a baby in a baby stroller, that a pickup location that is downhill in elevation from where the user 426 is currently located is desirable. The user 426 may thus provide input specifying a downhill pickup location, and one or more of the smartphone 428, vehicle 430, and/or a server operating in conjunction therewith may access map and terrain data to ascertain a downhill pickup location relative to the current location of the user 426 as determined based on the current location of the smartphone 428.

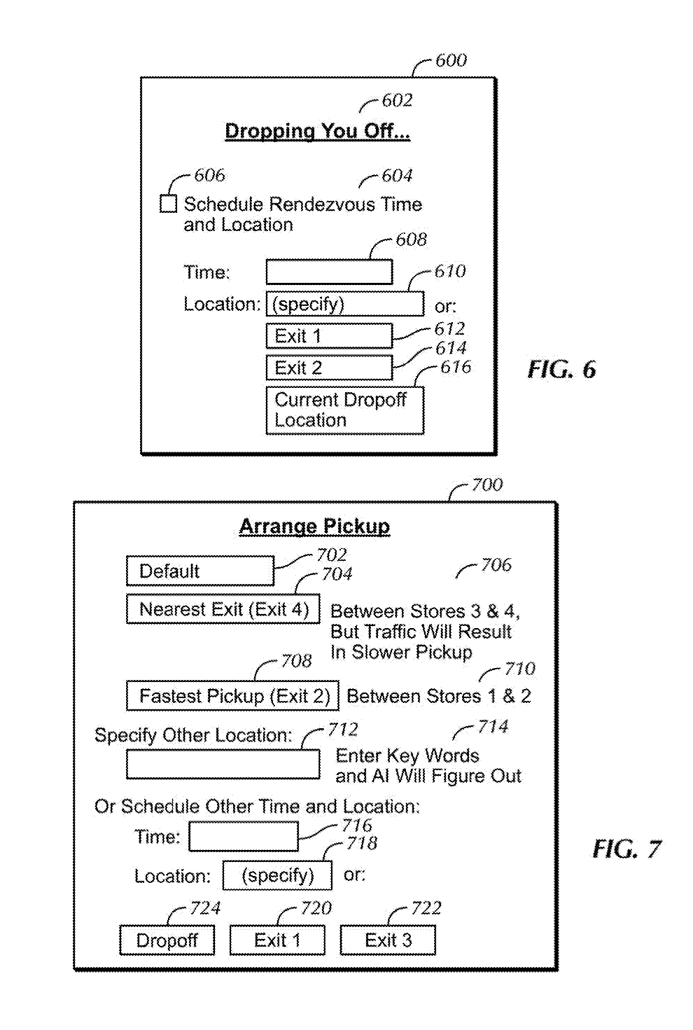

Now describing FIG. 5, it shows example logic that may be executed by a device for undertaking present principles. The logic of FIG. 5 may be executed in whole or in part by one or more of a self-driving vehicle, a user's personal device such as the user's smart phone, and/or a server, all of which may be in communication with each other. FIG. 5 will be described in reference to a single device for simplicity.

Beginning at block 500, a user is dropped off at a location that may have been designated by the user. The logic may then proceed to block 502, where the logic may identify a parking location and self-park the vehicle at the parking location. The parking location may have been identified by the device, for instance, by identifying an establishment associated with the drop off location based on GPS coordinates received by a GPS transceiver on the vehicle while dropping the user off. A database of establishments and associated GPS coordinates may then be accessed to identify a match to the received GPS coordinates and hence the associated establishment (e.g., the shopping center 402). Once the establishment is identified, the device may then access map data for the establishment to identify a parking location (such as a parking garage) and associated GPS coordinates for the parking location, and then the device may control the vehicle to navigate to the parking location and locate an empty parking space in which the vehicle may be parked. An empty parking space may be identified, for example, based on input from a camera on the vehicle that images the vehicle's surroundings to thus identify an empty parking spot using image analysis and/or object recognition.

From block 502 the logic may next proceed to block 504. At block 504 the logic may await user input to rendezvous with the user. The logic may then proceed to block 506 where the logic may receive a command to rendezvous with the user. For example, the command may have been input by the user using the user's smartphone, which may then be transmitted to a server in communication with the smartphone, and then the server may relay the command to the vehicle. Responsive to receipt of the command, the vehicle may startup.

After block 506, the logic may proceed to block 508. At block 508 the logic may identify at least one criterion or parameter for rendezvous with the user, as may have been indicated by the user. For example, the criterion or parameter may be for pickup at a nearest available pickup location relative to a current location of the user, as may be determined based on GPS coordinates received from the GPS transceiver of the user's smartphone. As another example, the criterion or parameter may be for pickup at a fastest available pickup location given the current location of the user and the current location of the vehicle so that the two may rendezvous at the earliest possible time.

After block 508 the logic may move to block 510. At block 510 the logic may receive data regarding the current location of the vehicle. This data may be received, for example, from a GPS transceiver on the vehicle. Then at block 512 the logic may receive data regarding the current location of the user, which, as indicated above, may be received from a GPS transceiver on the user's smartphone, which is assumed to be with the user. From block 512 the logic may proceed to block 514.

At block 514 the logic may access building layout data, road data, map data, etc. (such as by communicating with a server over the Internet) which may help the device identify an appropriate rendezvous location and how to navigate thereto by using such data to identify potential routes and perform a distance and travel time analysis on those routes. The logic may then move to block 516 where the logic may access traffic condition data over the Internet, such as via a website posting current traffic condition data or via a server maintaining traffic condition data for the establishment itself.

After block 516 the logic may proceed to block 518. At block 518 the logic may identify a pickup/rendezvous location based on the current locations of the user and vehicle, based on the criterion or parameter, based on the current traffic conditions, and based on the building layout, road, and map data. For example, using the data identified/received at blocks 508-516, the logic may identify all possible pickup locations for the establishment and surrounding areas (e.g., locations within a threshold radius of the current location of the user). The possible pickup locations may be identified based on them being previously designated as pickup locations per the map data, for instance. Possible pickup locations may also be identified based on building layout data, published by the establishment, that indicates pickup locations for the establishment.

Of the possible pickup locations, the logic may then select at least those that conform to the criteria and/or parameters indicated by the user, such as one that is nearest the user or one that conforms to a location physical characteristic specified by the user, such as one that is downhill of the user. The logic may also select a threshold number of alternate pickup locations at the establishment and surrounding areas (such as across the street from a building in which the user is located), or all other pickup locations at the establishment and surrounding areas, whether those pickup locations conform to the criteria/parameters or not.

Once pickup locations are selected, the logic may use direction-providing software and/or the map data to, based on the current locations of the vehicle and user, identify all potential routes from the vehicle to the user and perform distance and travel time computations on those routes to identify respective distances and travel times for those routes to the selected pickup locations. Current traffic condition data may also be accessed to identify any traffic congestion along those routes and to calculate any added time that it would take the vehicle to travel that route based on the current traffic conditions.

Additionally, after travel times for the vehicle routes have been ascertained in light of current traffic conditions, the logic may select the vehicle route with the least amount of travel time to a user-indicated pickup location or to the pickup location identified as nearest the user. If a user-indicated criterion for pickup was to be picked up as fast as possible, the logic may use the user's current location, a preselected average walking time, traffic conditions, building layout data, and speed limits for the vehicle to travel to the various selected pickup locations, and then identify the pickup location at which the user and vehicle can rendezvous at the fastest based on calculated vehicle travel times and user walking times to each pickup location. In this way, for instance, a pickup location may be selected at which a user and vehicle may arrive at near simultaneously, or at least may rendezvous at faster than at any other pickup location.

Still in reference to FIG. 5, from block 518 the logic may move to block 520. At block 520 the logic may inform the user of the identified rendezvous location, such as by transmitting GPS coordinates for the location to the user's smartphone so that the user may be presented with a user interface (UI) for navigating to the rendezvous location based on the transmitted GPS coordinates.

After block 520 the logic may move to block 522 where the logic may control and/or command the vehicle to travel to the rendezvous location to pickup the user. For instance, a server may transmit signals to the vehicle to control the vehicle to make turns, accelerate, or decelerate at given points to travel to the rendezvous location. The vehicle may also control itself based on its own navigation capabilities, and/or the user's smartphone may also transmit wireless commands to control the vehicle accordingly.

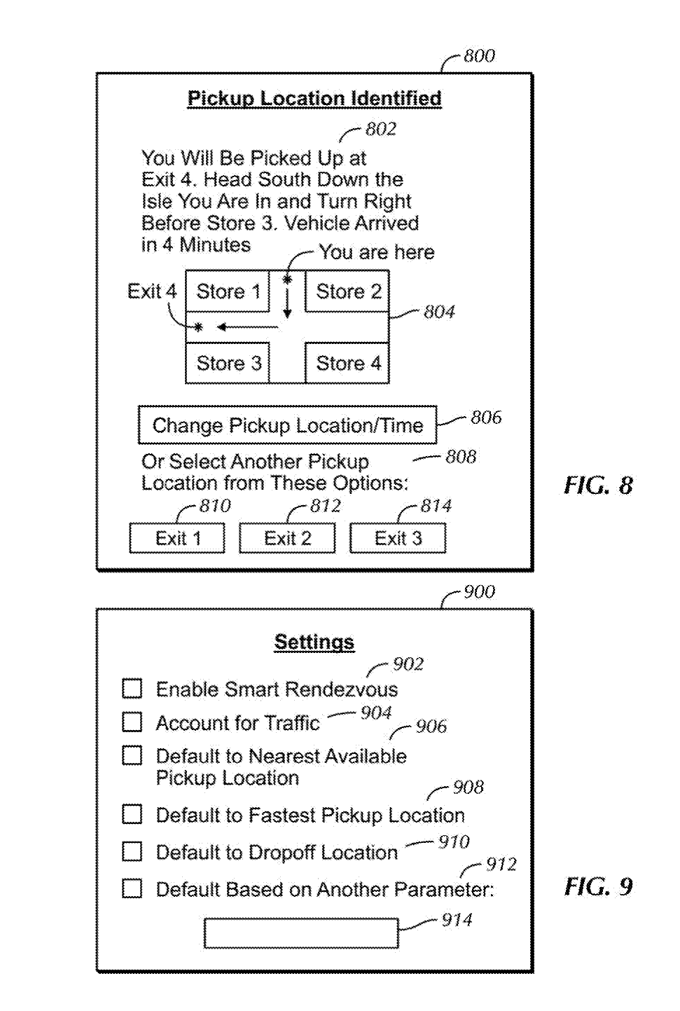

Before moving on to the description of FIG. 6, it is to be understood that current locations for the user and vehicle, as well as navigation for each, may be determined other ways in addition to or in lieu of using GPS coordinates. For example, dead reckoning can be used based on input from accelerometers and gyroscopes on the user's smartphone and vehicle to track their respective locations based on the dead reckoning algorithms and map/building layout data. Indoor “GPS” may also be used, as well as input from various Bluetooth beacons or wireless access points that indicate a location, as received at respective wireless transceivers on the smartphone and vehicle.

Location may even be triangulated based on beacon signals so that the smartphone or vehicle can identify its location based on signals from those beacons/access points. In addition to or in lieu of the foregoing, received signal strength indication (RSSI) may be also used to identify a distance of the smartphone or vehicle from the known locations of various beacons/access points from which signals are being received, and hence a location of the smartphone or vehicle may be identified based on the distances to each beacon/access point.

Camera and microphone input may also be used to identify location using location recognition and sound recognition, respectively. For instance, an image from a camera may be used to identify a particular store in the image based on a comparison to reference images that are accessible to the device, and hence identify the user as being at or proximate to the store. The current location of the user or vehicle may also be identified based on sounds sensed by the smartphone or vehicle's microphone, which may then be compared to sound reference data to identify sounds or words associated with a given location, and hence identify the current location of the user or vehicle.

Now in reference to FIG. 6, it shows an example user interface (UI) 600 presentable on the display of a user's device in accordance with present principles. The UI 600 may be presented when a vehicle drops a user off. The UI 600 thus includes an indication 602 that the user is being dropped off, along with an option 604 selectable using the check box 606 to enable receipt, via the UI 600, of user input to schedule a rendezvous time and location. A rendezvous time may then be specified based on input to input box 608, while a rendezvous location may be specified based on input to input box 610. Alternatively to providing input to input box 610, a user may also select a particular rendezvous location by selecting one of the options 612 and 614 that indicate respective rendezvous locations. Additionally, option 616 may be selected to select the location at which the user is being dropped off as the rendezvous location.

Once time and location have been specified, the vehicle may park itself and continually or periodically monitor travel times to the selected rendezvous location. The vehicle may then leave the parking spot in which it is parked at the time at which rendezvous is to occur, minus travel time to the route. For instance, if rendezvous time is 5:00 p.m. and current travel time to the rendezvous location is five minutes, the vehicle may leave the parking spot at 4:55 p.m. to arrive at the rendezvous location at the rendezvous time.

Note that the user may, but need not, prearrange a rendezvous time and location when being dropped off. The user may also arrange a rendezvous time and location at a later time, or simply arrange a rendezvous when ready to be picked up. For this, the UI 700 shown in FIG. 7 may be presented on the display of the user's smartphone. It may be presented, for instance, responsive to opening an associated application for undertaking present principles but after the user has been dropped off somewhere.

The UI 700 may include a first, default option 702 for rendezvous location. Default option 702 may be a default to either rendezvous at the nearest possible rendezvous location to the user, or to rendezvous at a location that results in rendezvous as fast as possible, for instance. The default may be preselected by the user using, for example, the UI 900 of FIG. 9 which will be described below.

An option 704 may also be presented for the user to select rendezvous at the nearest location to the user, with the option 704 indicating the particular location as shown (in this case, building exit 4). Information 706 may be presented adjacent to the option 704 that indicates how the particular location may be located relative to the current location of the user, and that indicates whether traffic will affect rendezvous time at the particular location.

Option 706 may be presented for the user to select rendezvous that can occur the fastest, with the option 706 indicating the particular location as shown (in this case, building exit 2). Information 710 may be presented adjacent to the option 708 that indicates how the particular location may be located relative to the current location of the user.

The UI 700 may also include an input box 712 at which a user may specify another location, along with accompanying information 714 indicating that key words may be entered into the box 712 and that artificial intelligence may then be used to perform an analysis on the key words to determine a particular rendezvous location based on or conforming to the key words. For instance, “downhill from here” may be entered into the box 712, and then artificial intelligence may be used to identify a parameter for rendezvous as a location at a lesser altitude or down a hill from the current location of the user.

The UI 700 may also include an input box 716 at which a particular rendezvous time may be specified, as well as an input box 718 at which a particular rendezvous location may be specified. Alternatively to providing input to input box 718, a user may also select a particular rendezvous location by selecting one of the options 720 and 722 that indicate respective rendezvous locations. Additionally, option 724 may be selected to select the location at which the user was dropped off as the rendezvous location.

Now in reference to FIG. 8, it shows a UI 800 that may be presented on the display of the user's personal device once a rendezvous location has been identified that conforms to the user's rendezvous request. Information 802 may be presented that indicates a particular rendezvous location at which the user will be picked up by the user's vehicle. The information 802 may also indicate text directions for traveling from the user's current location to the rendezvous location, as well as indicating a time at which the vehicle is estimated to arrive at the rendezvous location.

A graphical map 804 of the user's surroundings may also be presented on the UI 800. The map 804 may indicate a layout of the user's surroundings, a current location of the user, the rendezvous location, and arrows or other graphical indicators for traveling to the rendezvous location.

Still further, the UI 800 may include a selector 806 that is selectable to, for instance, present the UI 700 so that the user may change the rendezvous location and/or time, or otherwise select another rendezvous location and/or time. A prompt 808 may also indicate that options 810, 812, and 814 may be selected to select another rendezvous location as respectively indicated on the face of the options 810, 812, and 814. Though not shown for clarity, an option for selecting the location at which the user was previously dropped off may also be presented beneath the prompt 808 for selection by the user.

FIG. 9 shows a settings user interface 900 that may be presented on the user's device for configuring settings of the vehicle, user's device, server, and/or application that is being used for undertaking present principles. Each option addressed below may be selected by checking the respective check box shown adjacent to each option using, for example, touch input or input using a mouse.

Option 902 may be selected to enable user-vehicle rendezvous in accordance with present principles, such as at a nearest exit to the user or at a location at which rendezvous can occur the fastest. Option 904 may be selected to enable traffic condition data to be used when determining rendezvous location as described herein.

Option 906 may be selected to establish a default for rendezvous as a nearest available rendezvous location to the user and that, e.g., may then be associated with option 702 described above. Again, default may be a default to rendezvous at a nearest possible rendezvous location to the user, to rendezvous at a location that results in rendezvous as fast as possible, or to rendezvous per another user-specified parameter or criterion. Option 908 may be selected to establish a default for rendezvous as a given rendezvous location allowing the fastest rendezvous of all possible locations. Option 910 may be selected to establish a default for rendezvous as being whatever location the user was previously dropped off at during the same trip. Additionally, the UI 900 may include an option 912 to default for rendezvous based on other user-specified criteria or parameters as input to input box 914.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory signal and/or a signal per se.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A vehicle, comprising:
an engine;
a drive train and chassis;
a battery;
a processor; and
storage accessible to the processor and bearing instructions executable by the processor to:
receive data from a device different from the vehicle;
based on the data, identify a location at which to rendezvous with a person; and
control the vehicle to rendezvous with the person at the location.

2. The vehicle of claim 1, wherein the instructions are executable by the processor to:
based on the data, identify at least one parameter for rendezvous with the person; and
based on identification of the at least one parameter, identify the location.

3. The vehicle of claim 2, wherein the at least one parameter pertains to a first exit of a building at which rendezvous with the person can occur faster than rendezvous with the person at other exits of the building.

4. The vehicle of claim 3, wherein the instructions are executable by the processor to:
based on identification of the at least one parameter and based on identification of data pertaining to traffic adjacent to the building, identify the location.

5. The vehicle of claim 2, wherein the instructions are executable by the processor to:
transmit data to the device indicating the location.

6. The vehicle of claim 2, wherein the at least one parameter pertains to a first exit of a building nearer to a current location of the person than other exits of the building.

7. The vehicle of claim 2, wherein the at least one parameter is indicated by the person.

8. The vehicle of claim 1, wherein the location is a first location, wherein the first location is associated with a building, wherein the data comprises data indicating the first location, and wherein the first location is different from a second location associated with the building at which the person was dropped off.

9. A method, comprising:
receiving data pertaining to a location of a device;
receiving data pertaining to a location of a vehicle different from the device;
identifying at least one criterion for pickup of a person by the vehicle; and
identifying a rendezvous location for pickup of the person.

10. The method of claim 9, comprising:
controlling the vehicle to travel to the rendezvous location.

11. The method of claim 9, comprising:
issuing a command to the vehicle to travel to the rendezvous location.

12. The method of claim 9, wherein the method is performed by the device.

13. The method of claim 9, wherein the method is performed by a server separate from the device and separate from the vehicle.

14. The method of claim 9, wherein the at least one criterion pertains to one or more of:
an available location nearest the person at which the person can be picked up, an available location at which the person can be picked up faster than at other locations, at least one location physical characteristic as indicated by the person.

15. A first device, comprising:
a processor; and
storage accessible to the processor and bearing instructions executable by the processor to:
receive first data from a second device different from the first device;
receive second data from a vehicle different from the first and second devices;
based on the first and second data, identify a location at which the vehicle is to rendezvous with a person; and
command the vehicle to rendezvous with the person at the location.

16. The device of claim 15, wherein the device is a server.

17. The device of claim 15, wherein the instructions are executable by the processor to:
identify at least one parameter for rendezvous with the person; and
based on identification of the at least one parameter, identify the location.

18. The device of claim 17, wherein the at least one parameter pertains to one or more of: a building exit at which rendezvous with the person can occur faster than rendezvous with the person at other building exits based on exit proximity to the person, a building exit at which rendezvous with the person can occur faster than rendezvous with the person at other building exits based on at least one current traffic condition, a building exit that is nearest to a current location of the person.

19. The device of claim 17, wherein the at least one parameter pertains to a height of the location at which the vehicle is to rendezvous with the person in relation to a current location of the person.

20. The device of claim 17, wherein the instructions are executable by the processor to:
access building layout data to identify the location.

21. An apparatus, comprising:
a first processor;
a network adapter; and
storage bearing instructions executable by a second processor of a device for:
presenting a user interface (UI) on a display accessible to device;
receiving, via the UI, input for a user to be picked up by a self-driving vehicle, the input indicating at least one criterion for pickup; and
issuing a command to the self-driving vehicle to rendezvous with the user based on the criterion;
wherein the first processor transfers the instructions to the device over a network via the network adapter.
